(19) United States
(12) Patent Application Publication
(10) Pub. No.: US 2015/0274230 A1
(43) Pub. Date: Oct. 1, 2015

(54) MOTORCYCLE SEAT WITH ENHANCED TRACTION

(71) Applicant: GUTS, Inc., Diamond Springs, CA (US)

(72) Inventor: JAMEY GREGG, Diamond Springs, CA (US)

(21) Appl. No.: 14/668,888

(22) Filed: Mar. 25, 2015

Related U.S. Application Data
(60) Provisional application No. 61/969,943, filed on Mar. 25, 2014.

(51) Int. Cl. B62J 1/22

(52) U.S. Cl. CPC B62J 1/22

(57) ABSTRACT

A motorcycle seat assembly with enhanced traction to prevent a rider from sliding on the seat while operating a motorcycle comprises a base layer with a first fastener affixed to an outer edge of the base layer, the base layer being coupled to the motorcycle, a foam member disposed on the base layer and having a plurality of second fasteners affixed to a plurality of grooves on a top portion of the foam member, and a cover with a plurality of third fasteners affixed to a bottom portion of the cover and a fourth fastener affixed to an outer edge of the cover. The cover is oriented such that the plurality of third fasteners engages the plurality of second fasteners and the fourth fastener engages with the first fastener thereby securing the cover around the base layer and the foam member when placed in the motorcycle.

### RELATED APPLICATIONS

This application claims priority from the U.S. provisional application with Ser. No. 61/969943 filed on Mar. 25, 2014. The disclosure of the provisional application is incorporated herein as if set out in full.

### BACKGROUND OF THE DISCLOSURE

1. Technical Field of the Disclosure

The present embodiment relates in general to motorcycle seats. More specifically, the present disclosure relates to an improved motorcycle seat assembly with enhanced traction to prevent a rider from sliding on the seat while operating the motorcycle.

2. Description of the Related Art

Riders of motorcycles, and in particular off-road motorcycles tend to slide backwards on the seat during acceleration or slide forward on the seat during heavy braking. This can create an unsafe situation for the rider affecting control of the vehicle and the stability of the rider. Current grip style covers and seats for motorcycles do not provide adequate traction to the rider and/or are difficult to install. Currently available seat covers are often stapled to the seat, which makes it difficult to remove and replace.

One conventional motorcycle seat comprises a seat assembly comprising a cover that is quickly and easily connected to the seat base. The tool and fastener free connection of the seat cover provides for a convenient, repeatable, and secure connection with the seat base. This seat assembly provides for the convenient and expeditious connection of a plurality of seat assembly elements. The fastener free connection between the multiple components of the seat assembly provides for the economical manufacture and assembly of the seat assembly. However, such a seat assembly does not provide a gripping means to enhance traction to stabilize the motorcycle the rider during acceleration and deceleration.

Other existing prior art discloses a motorcycle seat in the form of a tandem seat assembled from a seat cushion comprising a plastic foam molded part, a pad layer of an open pore polyether foam material, a ventilation layer of a spacer fabric provided upon the pad layer and a seat cover which is a breathable, and water-tight membrane. However, such a motorcycle provides little comfort to the rider, and does little to prevent the rider from sliding on the seat. Furthermore, many such seats cannot be easily installed and/or removed from the motorcycle.

Some conventional motorcycle seats are adapted to support a rider's body in a forward leaning position on the seat for racing. The anterior portion of the elongated seat tends to be recessed so as to form a cradle. The cradle helps the rider maintain a forward leaning position while riding at high speeds and while undergoing high changes in forward/backwards and side to side acceleration. The cradle has a smaller radius of curvature in the rear portion of the cradle to provide a steep grade upon which the rider may be supported. However, such a motorcycle seat cannot be easily installed and/or removed from the motorcycle.

Still other conventional motorycle seats comprise a motorcycle seat cushion with a base having an array of upstanding air cells. The air cells are interconnected such that pressure is spread across a wider area to reduce pressure points on the rider. The external air flow pathway between the cells allows the air to circulate among the cells to disperse heat and moisture. The midline pathway is positioned under the perineum and coccyx of the rider to provide pressure relief to the perineum, prostate and coccyx of the male rider. The cushion may comprise a cover having top and side walls constructed from a two-way stretch material and the cover may have air vents that functionally align with at least some of the air flow pathways so as to promote the flow of ambient air into the air flow pathways. However, such a motorcycle seat does not provide the rider with traction control to prevent sliding on the seat while operating a motorcycle.

Therefore, there is a need for an improved motorcycle seat assembly with enhanced traction to prevent a rider from sliding on the seat while operating a motorcycle. Such a needed motorcycle seat assembly would provide grooves on the foam member to provide comfort and stabilize the rider during acceleration and deceleration. Such a motorcycle seat assembly would provide a seat cover that is attached to the seat utilizing fastener strips which allows the rider to easily remove and replace the foam member without the use of complicated tools or skills. Finally, such a needed device would be economical and would require less time and manpower to install.

### SUMMARY OF THE DISCLOSURE

To minimize the limitations found in the prior art, and to minimize other limitations that will be apparent upon the reading of the specification, the preferred embodiment of the present invention provides a motorcycle seat assembly configured to enhance traction to prevent a rider from sliding on a motorcycle seat while operating a motorcycle. The motorcycle seat assembly comprises a base layer, a foam member and a cover. The cover is securely fastened on the base layer and the foam member and the motorcycle seat assembly is installed on a motorcycle. The base layer comprises at least one first fastener affixed to an outer edge thereof. The base layer is configured to be mechanically coupled to the motorcycle. The foam member comprises a top portion and a bottom portion. The top portion of the foam member includes a plurality of grooves that is affixed with a plurality of second fasteners. Specifically, each groove is affixed with each second fastener. The bottom portion of the foam member is disposed over the base layer. The plurality of grooves is formed in the foam member to enhance fraction of the motorcycle seat. The plurality of grooves with enhanced fraction prevents the rider from sliding on the motorcycle seat while operating the motorcycle. The foam member is disposed on the base layer and the plurality of grooves is oriented substantially parallel to one another on the top portion of the foam member. The plurality of grooves on the foam member provides enhanced traction to stabilize the rider of the motorcycle without adding additional weight to the motorcycle seat. The cover includes a plurality of third fasteners affixed to a bottom portion thereof and at least one fourth fastener affixed to an outer edge of the cover. The cover is oriented such that the plurality of third fasteners is engaged with the plurality of second fasteners and the at least one fourth fastener with the at least one first fastener thereby securing the cover around the base layer and the foam member when placed in the motorcycle. The motorcycle seat assembly is secured to the motorcycle by any type of fasteners such as bolts attached to a bottom portion of the base layer.

The first, second, third and fourth fasteners are any fastening means selected from the group consisting of snap fasteners, quarter-turn fasteners, pin fasteners, clips, staples and hook and loop-type fasteners. The base layer comprises a material selected from a group consisting of: plastic, fiberglass and carbon fiber.

It is a first objective of the present invention to provide an improved motorcycle seat assembly exhibiting enhanced available traction to prevent a rider from sliding on the seat while operating a motorcycle.

A second objective of the present invention is to provide a motorcycle seat assembly that provides grooves on the foam member to provide comfort and stabilize the rider.

A third objective of the present invention is to provide a motorcycle seat assembly that provides a seat cover that is attached to the seat utilizing fastener strips which allows the rider to easily remove and replace the foam member without the use of complicated tools or skills.

A fourth objective of the present invention is to provide a motorcycle seat assembly that is economical and requiring less time and manpower to install, and less rework.

A fifth objective of the present invention is to provide a motorcycle seat assembly that is easily installed and/or removed from the motorcycle.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 illustrates a perspective view of a motorcycle seat assembly in accordance with the preferred embodiment of the present invention;

FIG. 2 illustrates a perspective view of a motorcycle seat assembly with a cover shown in FIG. 1 being removed to better show the internal construction of the motorcycle seat assembly;

FIG. 3 illustrates a perspective view of a foam member with a plurality of second fasteners shown in FIG. 2 being removed in accordance with the preferred embodiment of the present invention;

FIG. 4A illustrates a perspective view of the cover shown in FIG. 1 in accordance with the preferred embodiment of the present invention;

FIG. 4B illustrates a blown up view of a cover showing at least one fourth fastener along an outer edge of the cover in accordance with the preferred embodiment of the present invention;

FIG. 4C illustrates an enlarged view of the cover showing a plurality of third fasteners in accordance with the preferred embodiment of the present invention;

FIG. 5 illustrates a perspective view of a foam member partially attached to the cover of the motorcycle seat in accordance with the preferred embodiment of the present invention;

FIG. 6 illustrates a top perspective view of a base layer with the at least one first fastener partially attached to an outer edge thereof in accordance with the preferred embodiment of the present invention; and

FIG. 7 illustrates a bottom perspective view of the motorcycle seat assembly, illustrating the at least one fourth fastener attached to the at least one first fastener in accordance with the preferred embodiment of the present invention.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

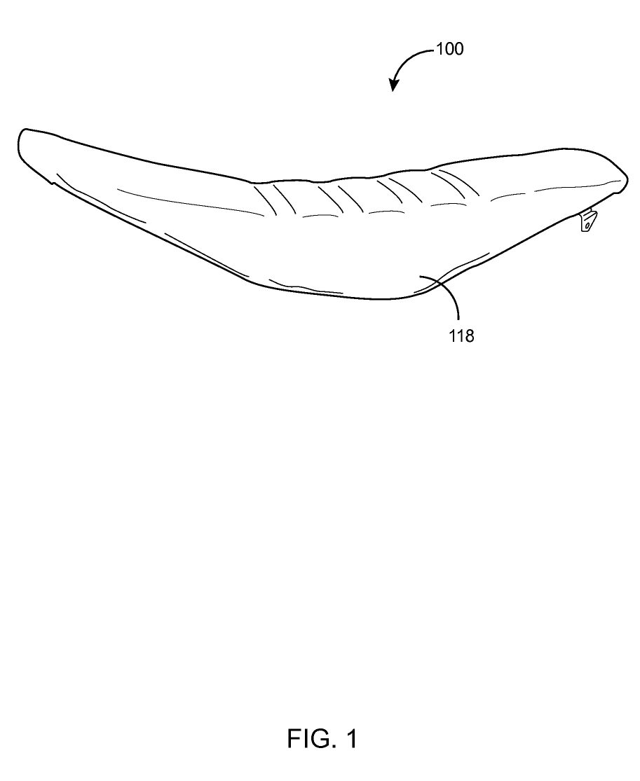

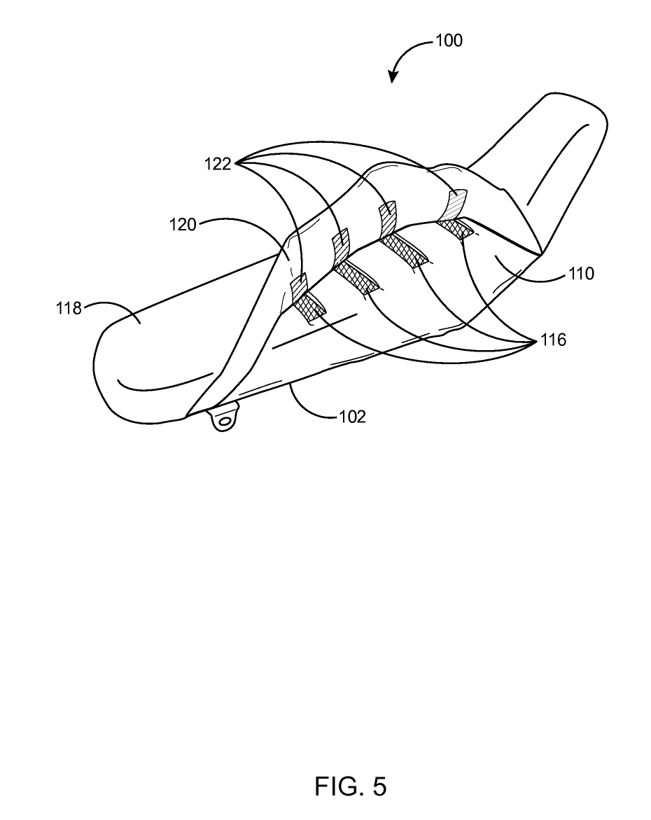

Turning first to FIG. 1, a perspective view of a motorcycle seat assembly 100 is shown in accordance with the preferred embodiment of the present invention. The motorcycle seat assembly 100 provides enhanced traction to prevent a rider from sliding relative to the motorcycle seat while operating a motorcycle. As shown best in FIG. 5, the motorcycle seat assembly 100 comprises a base layer 102, a foam member 110 and a cover 118. The cover 118 is securely fastened on the base layer 102 and the foam member 110 when the motorcycle seat assembly 100 is installed on the motorcycle, not shown.

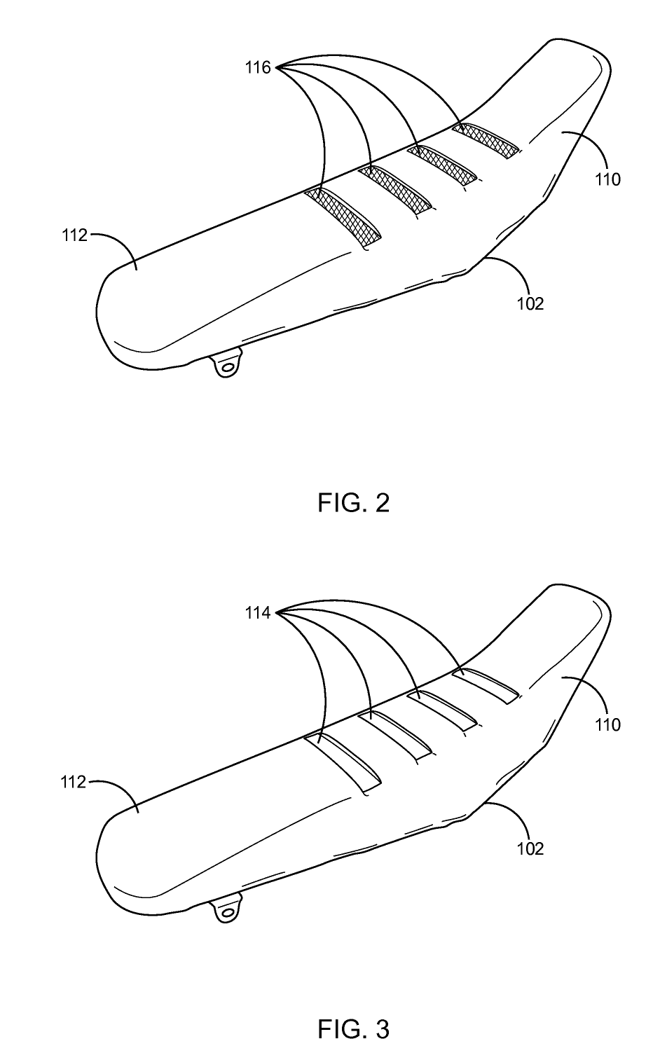

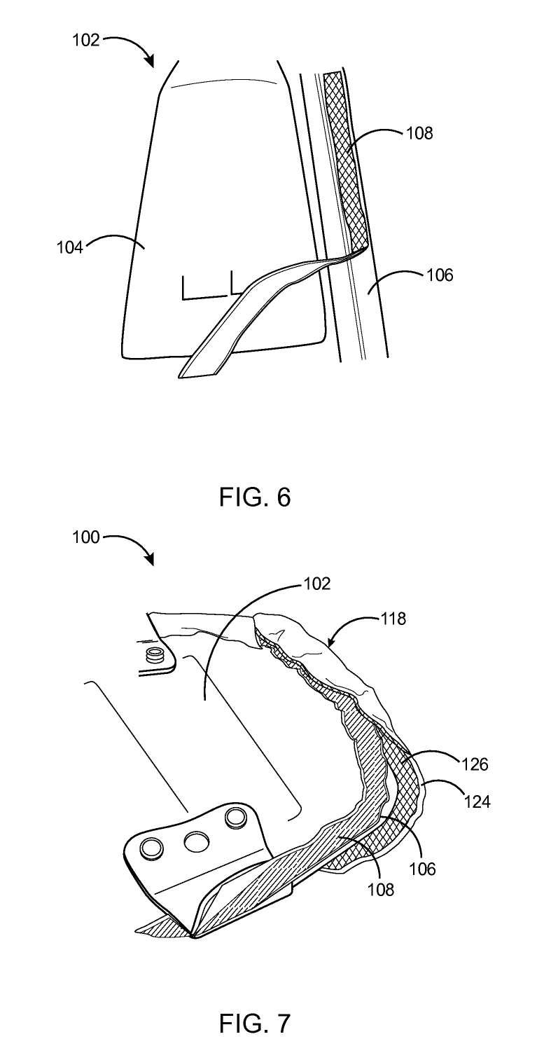

The base layer 102 comprises at least one first fastener 108 affixed to an outer edge 106 thereof (See FIG. 6). The base layer 102 is configured to be mechanically coupled to a motorcycle. The foam member 110 as shown in FIG. 2 comprises a top portion 112 and a bottom portion (not shown). The top portion 112 of the foam member 110 includes a plurality of grooves 114 (See FIG. 3) that are affixed with a plurality of second fasteners 116 (See FIG. 2). Specifically, each groove 114 is affixed with each second fastener 116. The bottom portion (not shown) of the foam member 110 is disposed over the base layer 102 as shown in FIG. 2. The plurality of grooves 114 is formed in the foam member 110 to enhance traction of the motorcycle seat. The plurality of grooves 114 with enhanced traction prevents the rider from sliding on the motorcycle seat while operating the motorcycle.

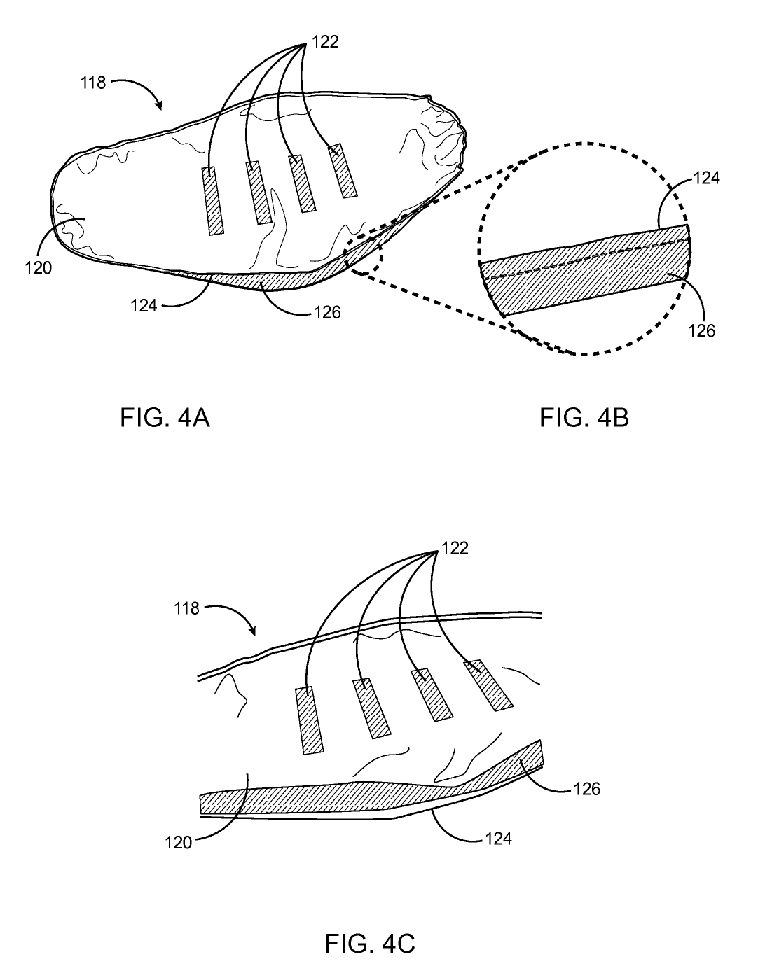

FIGS. 4A through 4C illustrate the cover 118 shown in FIG. 1 in accordance with the preferred embodiment of the present invention. The cover 118 includes a plurality of third fasteners 122 affixed to a bottom portion 120 thereof and at least one fourth fastener 126 affixed to an outer edge 124 of the cover 118. The cover 118 is oriented such that the plurality of third fasteners 122 engages with the plurality of second fasteners 116 and the at least one fourth fastener 126 with the at least one first fastener 108 thereby securing the cover 118 around the base layer 102 and the foam member 110 when the seat is ready for fitment to the motorcycle as illustrated in FIG. 1.

The motorcycle seat assembly 100 is secured to the motorcycle by any type of fasteners such as bolts or screws attached to a bottom portion 104 of the base layer 102.

The first, second, third and fourth fasteners 108, 116, 122 and 126 are any fastening means selected from the group consisting of snap fasteners, quarter-turn fasteners, pin fasteners, clips, staples and hook and loop-type fasteners.

The base layer 102 shown in FIG. 6 comprises a material selected from the group consisting of plastic, fiberglass and carbon fiber. The at least one first fastener 108 is preferably, a hook or loop fastener strip that is affixed to the bottom portion 104 of the base layer 102 along the outer edge 106 by utilizing an adhesive means such as glue and/or staples.

The foam member 110 is disposed on the base layer 102 and the plurality of grooves 114 is oriented substantially parallel to one another on the top portion 112 of the foam member 110. In the preferred embodiment, although the foam member 110 shown in FIGS. 1 and 2 comprises four grooves, it is noted that the foam member 110 can include any number of grooves in accordance with the construction, and four grooves is merely shown as an example. Preferably, the plurality of second fasteners 116 is a hook and loop fastener, such as Velcro®. As illustrated in FIG. 5, the cover 118 is wrapped around the foam member 104 in such a way that the plurality of third fasteners 122 on the bottom portion 120 of the cover 118 aligns with the plurality of second fasteners 116 on the top potion 112 of the foam member 110 to facilitate proper attachment of the cover 118 with the foam member 110.

Preferably, the plurality of third fasteners 122 is a hook and loop fastener strip that is sewn or heat welded to the bottom portion 120 of the cover 118. The plurality of third fasteners 122 are oriented substantially parallel to one another and are configured to engage with the plurality of second fasteners 116 on the top portion 112 of the foam member 110. In addition, preferably, the at least one fourth fastener 126 is a hook or loop fastener strip that is sewn along the outer edge 124 of the cover 118. As shown in FIG. 7, the at least one fourth fastener 126 along the outer edge 124 of the cover 118 is configured to engage with the at least one first fastener 108 affixed to the outer edge 106 of the base layer 102. The cover 118 may comprise any materials known in the field including, but not limited to any high friction flexible material, such as rubber or foamed plasticized PVC (polyvinyl chloride).

In operation, the rider secures the base layer 102, foam member 110 and cover 118 utilizing the first, second, third and fourth fasteners 108, 116, 122 and 126 and placed on the motorcycle utilizing any type of fasteners attached to the bottom portion 104 of the base layer 102. The plurality of grooves 114 on the foam member 110 provides enhanced traction to stabilize the rider of the motorcycle without adding additional weight to the motorcycle seat. The first, second, third and fourth fasteners 108, 116, 122 and 126 are used to secure the components together allow the rider to easily install, remove, and/or interchange the components of the motorcycle seat assembly 100 at any time without the use of complicated tools or skills.

It shall be appreciated that the components of motorcycle seat assembly 100 described in several embodiments herein may comprise any alternative known materials in the field and be of any color, size and/or dimensions. It shall be appreciated that the components of the motorcycle seat assembly 100 described herein may be manufactured and assembled using any known techniques in the field.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. A motorcycle seat assembly comprising:
a base layer having at least one first fastener affixed to an outer edge thereof, the base layer configured to be mechanically coupled to a motorcycle;
a foam member disposed over the base layer, the foam member having a plurality of grooves on a top portion thereof and a plurality of second fasteners affixed to the plurality of grooves; and
a cover having a plurality of third fasteners affixed to a bottom portion thereof and at least one fourth fastener affixed to an outer edge of the cover, the cover being secured around the base layer and the foam member;
whereby a plurality of grooves provides an enhanced traction to prevent a rider from sliding on the motorcycle seat while operating the motorcycle.

2. The motorcycle seat assembly of claim 1 wherein the cover is oriented such that the plurality of third fasteners engages with the plurality of second fasteners and the at least one fourth fastener with the at least one first fastener thereby securing the cover around the base layer and the foam member when placed in the motorcycle.

3. The motorcycle seat assembly of claim 1 wherein the first, second, third and fourth fasteners are any fastening means selected from the group consisting of hook and loop-type fasteners, snap fasteners, quarter-turn fasteners, pin fasteners, clips, and staples.

4. The motorcycle seat assembly of claim 1 wherein the base layer comprises a material selected from a group consisting of: plastic, fiberglass and carbon fiber.

5. An improved motorcycle seat assembly comprising:
a base layer having at least one first fastener affixed to an outer edge thereof, the base layer configured to be mechanically coupled to a motorcycle;
a foam member disposed over the base layer, the foam member having a plurality of grooves on a top portion thereof and a plurality of second fasteners affixed to the plurality of grooves, wherein the plurality of grooves being configured to enhance traction of the motorcycle seat; and
a cover having a plurality of third fasteners affixed to a bottom portion thereof and at least one fourth fastener affixed to an outer edge of the cover, wherein the cover being secured around the base layer and the foam member when placed in the motorcycle;
whereby the plurality of grooves with enhanced traction prevents a rider from sliding on the motorcycle seat while operating the motorcycle.

6. The improved motorcycle seat assembly of claim 5 wherein the cover is oriented such that the plurality of third fasteners engages with the plurality of second fasteners and the at least one fourth fastener with the at least one first fastener thereby securing the cover around the base layer and the foam member when placed in the motorcycle.

7. The improved motorcycle seat assembly of claim 5 wherein the first, second, third and fourth fasteners are any fastening means selected from the group consisting of snap fasteners, quarter-turn fasteners, pin fasteners, clips, staples and hook and loop-type fasteners.

8. The improved motorcycle seat assembly of claim 5 wherein the base layer comprises a material selected from the group consisting of plastic, fiberglass and carbon fiber.

9. An improved motorcycle seat assembly comprising:
a base layer having at least one first fastener affixed to an outer edge thereof, the base layer configured to be mechanically coupled to a motorcycle;
a foam member having a top portion and a bottom portion that being disposed over the base layer, the foam member having a plurality of grooves on the top portion thereof and a plurality of second fasteners affixed to the plurality of grooves, wherein the plurality of grooves being configured to enhance traction of the motorcycle seat; and
a cover having a plurality of third fasteners affixed to a bottom portion thereof and at least one fourth fastener affixed to an outer edge of the cover, wherein the cover being oriented such that the plurality of third fasteners engages with the plurality of second fasteners and the at least one fourth fastener with the at least one first fastener thereby securing the cover around the base layer and the foam member when placed in the motorcycle;
whereby the plurality of grooves with enhanced traction prevents a rider from sliding on the motorcycle seat while operating the motorcycle.

10. The improved motorcycle seat assembly of claim 9 wherein the first, second, third and fourth fasteners are any fastening means is selected from the group consisting of snap fasteners, quarter-turn fasteners, pin fasteners, clips, staples and hook and loop-type fasteners.

11. The improved motorcycle seat assembly of claim 9 wherein the base layer comprises a material selected from the group consisting of plastic, fiberglass and carbon fiber.
